(19) United States
(12) Patent Application Publication
(10) Pub. No.: US 2026/0066570 A1
(43) Pub. Date: Mar. 5, 2026

(54) CONNECTOR

(71) Applicant: HIROSE ELECTRIC CO., LTD., Kanagawa (JP)

(72) Inventor: Yumi YABUKI, Kanagawa (JP)

(21) Appl. No.: 19/314,276

(22) Filed: Aug. 29, 2025

(30) Foreign Application Priority Data
Sep. 3, 2024 (JP) 2024-151575

(51) Int. Cl. H01R 13/502; H01R 13/639; H01R 13/64

(52) U.S. Cl. CPC H01R 13/502; H01R 13/64; H01R 13/639

(57) ABSTRACT

A connector connected to a counterpart connector includes a housing with a plurality of housing chambers, into each of which a high-voltage terminal fixed to a high-voltage cable is inserted. A connector position assurance is slidably provided in the housing along the insertion/removal direction of the high-voltage terminals to ensure the housing position relative to a counterpart housing. The housing includes at least one partition wall partitioning the housing chambers, a placing table positioned orthogonally to the insertion/removal and adjoining directions, on which the connector position assurance is slidably mounted, and at least one insulating rib extending from the individual partition walls in the pulling-out direction of the high-voltage terminals. The insulating ribs increase the clearance and creepage distances between adjacent high-voltage terminals and support the placing table or the connector position assurance protruding from the placing table.

### CROSS-REFERENCE TO RELATED APPLICATION

This application claims priority from Japanese Patent Application No. 2024-151575 filed with the Japan Patent Office on Sep. 3, 2024, the entire content of which is hereby incorporated by reference.

### BACKGROUND

### 1. Technical Field

The present disclosure relates to a connector connected to a counterpart connector.

### 2. Related Art

JP-A-2021-68497 discloses a connector in which a connector housing is provided with a guide groove that guides a fitting detection member from a temporary locking position to a main locking position. In the connector housing, a total of ten terminal housing chambers, including five terminal housing chambers in the transverse direction in two stages in the vertical direction, are formed. The connector housing is provided with a mounting wall portion further extending rearward from the rear surface and a pair of support walls supporting the mounting wall portion from below. The pair of support walls is formed integrally with two partition walls on both left and right sides among four partition walls partitioning the five terminal housing chambers on the upper stage. The individual support walls are formed in a substantially right triangular plate shape.

### SUMMARY

A connector according to the present disclosure is a connector connected to a counterpart connector, the connector including: a housing having a plurality of housing chambers into which a plurality of high-voltage terminals fixed to tip end portions of a plurality of high-voltage cables is inserted; and a connector position assurance that is provided in the housing so as to slide along an insertion/removal direction of the high-voltage terminal, and is slid from an unconnected position to a connection assurance position to ensure a position of the housing with respect to a counterpart housing when the housing is connected to the counterpart housing of the counterpart connector, in which the housing includes at least one partition wall that partitions the plurality of housing chambers, a placing table provided to face the housing chamber and the partition wall from one side of a supporting direction orthogonal to the insertion/removal direction and an adjoining direction of the housing chamber, and on which the connector position assurance is slidably installed, and at least one insulating rib extending from all the partition walls in a pulling-out direction of the high-voltage terminal, increasing a clearance distance and a creepage distance between the high-voltage terminals housed in the adjacent housing chambers, and supporting the placing table protruding from the housing in the pulling-out direction or the connector position assurance protruding from the placing table in the pulling-out direction.

### BRIEF DESCRIPTION OF DRAWINGS

FIG. 1 is a perspective view showing a connector and a counterpart connector according to an embodiment of the present disclosure;

FIG. 2 is a perspective view showing a state in which the connector according to the embodiment of the present disclosure is connected to the counterpart connector;

FIG. 3 is an exploded perspective view showing the connector and the counterpart connector according to the embodiment of the present disclosure;

FIG. 4 is a perspective view showing a housing of the connector according to the embodiment of the present disclosure;

FIG. 5 is a perspective view showing the housing, a retainer, and a connector position assurance of the connector according to the embodiment of the present disclosure;

FIG. 6 shows cross-sectional views (side views) for explaining an attachment procedure of the retainer in the connector according to the embodiment of the present disclosure;

FIG. 7 shows cross-sectional views taken along line A-A and line B-B in FIG. 6;

FIG. 8 is a cross-sectional view (side view) showing the connector according to the embodiment of the present disclosure;

FIG. 9 shows cross-sectional views (side views) for explaining the operation of the connector position assurance in the connector according to the embodiment of the present disclosure; and

FIG. 10 is a perspective view showing a state in which a connector according to an exemplary modification of the embodiment of the present disclosure is connected to a counterpart connector.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

In the above-described connector, the support walls are not formed on all the partition walls, and it is said that the clearance distance and the creepage distance between the terminals housed in the adjacent terminal housing chambers are insufficiently considered.

In consideration of the above circumstances, the present disclosure provides a connector capable of connecting a high-voltage electric circuit while ensuring smooth sliding of a connector position assurance (CPA).

A first aspect of the present disclosure is a connector connected to a counterpart connector, the connector including: a housing having a plurality of housing chambers into which a plurality of high-voltage terminals fixed to tip end portions of a plurality of high-voltage cables is inserted; and a connector position assurance that is provided in the housing so as to slide along an insertion/removal direction of the high-voltage terminal, and is slid from an unconnected position to a connection assurance position to ensure a position of the housing with respect to a counterpart housing when the housing is connected to the counterpart housing of the counterpart connector, in which the housing includes: at least one partition wall that partitions the plurality of housing chambers; and a placing table provided to face the housing chamber and the partition wall from one side of a supporting direction orthogonal to the insertion/removal direction and an adjoining direction of the housing chamber, and on which the connector position assurance is slidably installed; and at least one insulating rib extending from all the partition walls in a pulling-out direction of the high-voltage terminal, increasing a clearance distance and a creepage distance between the high-voltage terminals housed in the adjacent housing chambers, and supporting the placing table protruding from the housing in the pulling-out direction or the connector position assurance protruding from the placing table in the pulling-out direction.

In the first aspect of the present disclosure, the placing table adjacent to the housing chamber and the like from the supporting direction slidably supports the connector position assurance, and the insulating rib extending from the partition wall in the pulling-out direction increases the clearance distance and creepage distance between the high-voltage terminals, and supports the placing table or the connector position assurance protruding from the placing table in the pulling-out direction. According to this structure, the insulating rib provided to secure the necessary clearance distance and creepage distance can be used both as a portion that reinforces the placing table and a portion that supports the connector position assurance protruding from the placing table. As a result, it is possible to connect a high-voltage electric circuit while securing smooth sliding of the connector position assurance.

In the connector according to the first aspect of the present disclosure, in a second aspect of the present disclosure, the insulating rib may be formed thinner in the adjoining direction than the partition wall, and a step may be formed at a boundary between the partition wall and the insulating rib.

In the second aspect of the present disclosure, the insulating rib is thinner than the partition wall, and is connected to the partition wall via the step. According to this structure, in the case in which the high-voltage cable extending in the pulling-out direction from the high-voltage terminal in the housing chamber is bent in a direction in contact with the partition wall, the high-voltage cable is bent in two stages in contact with two portions, the tip end edge of the partition wall in the pulling-out direction and the tip end edge of the insulating rib in the pulling-out direction. As a result, the stress (load) related to the bending of the high-voltage cable can be distributed to two places, and the stress related to the bending of the high-voltage cable can be reduced as compared with the case in which the high-voltage cable is bent at one place. Consequently, it is possible to wire the high-voltage cable extending to the outside of the housing while being freely bent (improvement in the degree of freedom in routing the high-voltage cable).

In the connector according to the first or second aspect of the present disclosure, in a third aspect of the present disclosure, a tip end surface of the insulating rib in the pulling-out direction may include: a straight surface portion formed in parallel to the supporting direction on a side of the placing table; and an inclined surface portion bent with respect to the straight surface portion and inclined in an insertion direction of the high-voltage terminal toward a side opposite to the placing table.

Meanwhile, in the case of consideration of free routing of the high-voltage cable extending outward from the housing, it is preferable to form the insulating rib in a triangular plate shape by inclining the entire tip end surface of the insulating rib in the pulling-out direction. However, in the case in which the entire tip end of the insulating rib in the pulling-out direction is inclined, there is a possibility that a necessary clearance distance and creepage distance is not easily secured. Therefore, according to the third aspect of the present disclosure, since the tip end surface of the insulating rib in the pulling-out direction has the straight surface portion parallel to the supporting direction and the inclined surface portion inclined in the insertion direction, it is possible to secure the necessary clearance distance and creepage distance and secure the free routing of the high-voltage cable.

### Advantageous Effects of the Invention

According to the present disclosure, it is possible to connect a high-voltage electric circuit while securing smooth sliding of the connector position assurance. In the following, an embodiment of the present disclosure will be described with reference to the accompanying drawings. Note that X1, X2, Y1, Y2, Z1, and Z2 shown in the drawings indicate the left, right, front, back, top, and bottom. In addition, the “front-rear direction”, the “vertical direction”, and the “transverse direction” are examples of an “insertion/removal direction”, a “supporting direction”, and an “adjoining direction” in the claims in this order, and are orthogonal to each other. Note that in the present specification, terms indicating directions and positions are used. However, these terms are used for convenience of description and do not limit the technical scope of the present disclosure.

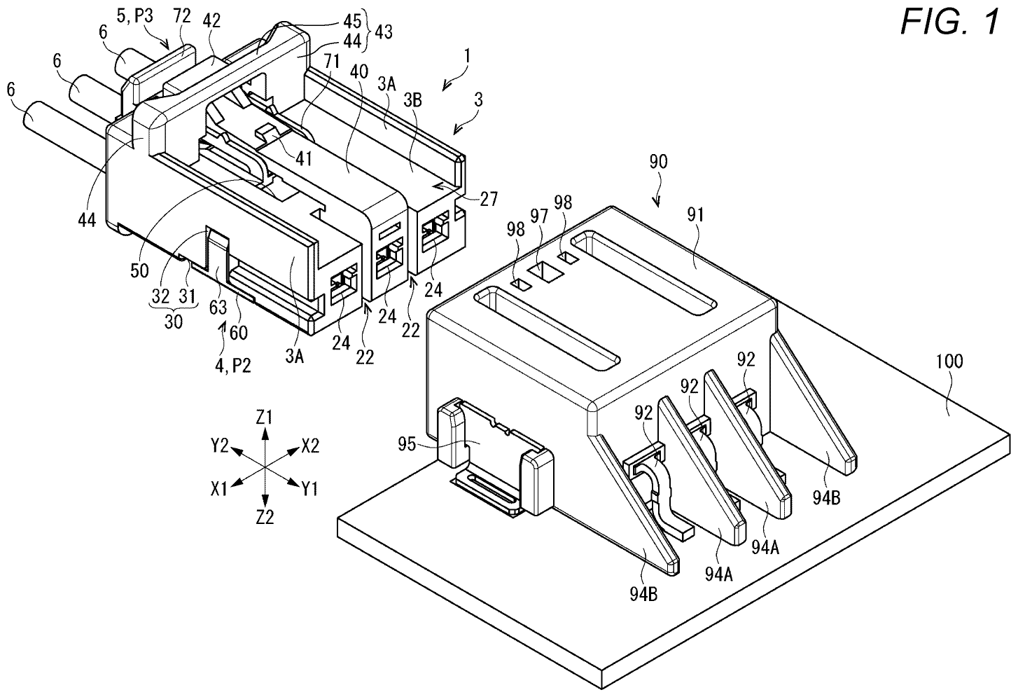

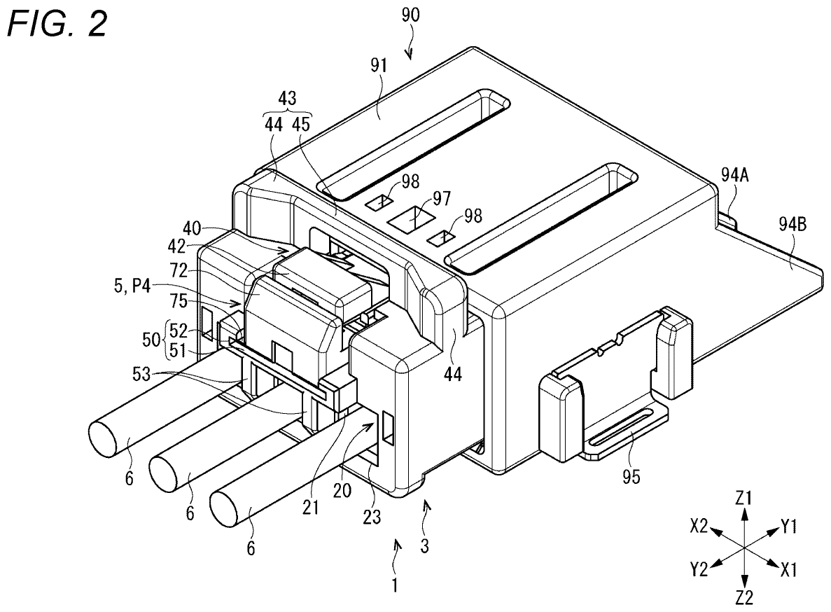

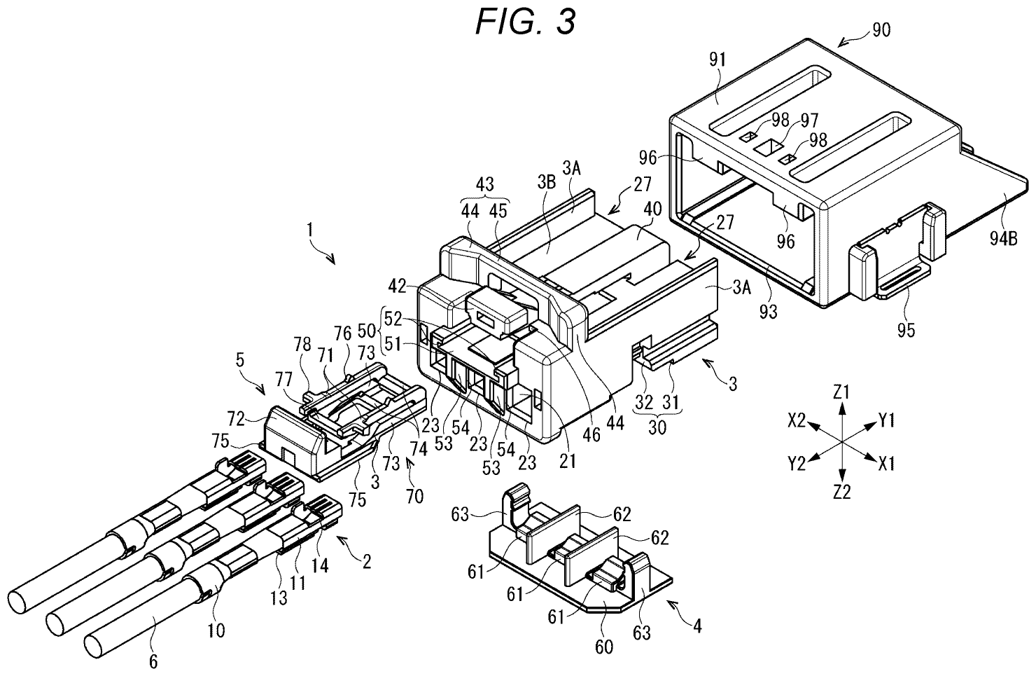

Referring to FIGS. 1 to 3, the outline of a connector 1 and a counterpart connector 90 according to the present embodiment will be described. FIG. 1 is a perspective view showing the connector 1 and the counterpart connector 90. FIG. 2 is a perspective view showing a state in which the connector 1 is connected to the counterpart connector 90. FIG. 3 is an exploded perspective view showing the connector 1 and the counterpart connector 90.

As shown in FIGS. 1 and 2, the connector 1 is connected (fitted) to the counterpart connector 90 mounted on an electric substrate 100 to form a high-voltage electric circuit. The connector 1 and the counterpart connector 90 can be adopted, for example, for connection of drive system electrical components, including an inverter, a converter, and a charger mounted on a hybrid vehicle, an electric vehicle, and the like. Note that in the present specification, the term “high voltage” refers to, for example, a voltage larger than 50 V.

### Counterpart Connector

In the following, the counterpart connector 90 will be described below prior to the description of the connector 1. The counterpart connector 90 is formed in which a plurality of (e.g., three) counterpart terminals 92 (see FIG. 1) is housed in a counterpart housing 91. Note that since the three counterpart terminals 92 have the same structure, one counterpart terminal 92 will be mainly described in the present specification.

The counterpart housing 91 is made of a non-conductive synthetic resin and formed in a rectangular tubular shape. On the rear end surface of the counterpart housing 91, a fitting port 93 that fits the connector 1 is opened (see FIG. 3). On the front end surface of the counterpart housing 91, two counterpart partition plates 94A are integrally molded so as to partition the three counterpart terminals 92 (see FIG. 1). In addition, two counterpart protection plates 94B are integrally molded on the front end surface of the counterpart housing 91 so as to be flush with the left and right side surfaces (see FIG. 1). The two counterpart protection plates 94B are provided to protect the counterpart terminals 92 on the left and right sides among the three counterpart terminals 92. As a specific example, in the case in which the plurality of counterpart housings 91 is packed in an embossed tape and the counterpart housing 91 rotates (moves) in the recess of the embossed tape, the counterpart protection plate 94B suppresses damage to the counterpart terminal 92. In addition, in the case in which the counterpart connector 90 mounted on the electric substrate 100 comes into contact with another substrate, the counterpart protection plate 94B suppresses damage to the counterpart terminal 92. Note that the two counterpart protection plates 94B may be omitted (not shown).

The counterpart housing 91 is fixed to the electric substrate 100 via a pair of reinforcement metal fittings 95 provided on both side surfaces in the transverse direction (see FIG. 1). On the top surface of the counterpart housing 91, a pair of guide projecting portions 96 is provided at intervals in the transverse direction (see FIG. 3). The guide projecting portion 96 extends in the front-rear direction and guides the connector 1 to be inserted into the counterpart housing 91. In the rear portion of the top wall of the counterpart housing 91, a first lock hole 97 and a pair of second lock holes 98 are drilled (see FIGS. 1 to 3). The first lock hole 97 opens at the center of the top wall in the transverse direction, and the pair of second lock holes 98 opens at symmetrical positions with the first lock hole 97 interposed. Both the lock holes 97 and 98 are quadrangular openings, and the first lock hole 97 is larger than the second lock hole 98.

The three counterpart terminals 92 are disposed at intervals in the transverse direction in the internal space of the counterpart housing 91. The counterpart terminal 92 is made of a conductive metal and bent in a crank shape. One (front side portion) of the counterpart terminal 92 in the front-rear direction is exposed through a front end wall of the counterpart housing 91, and the electric substrate 100 is fixed (soldered) (see FIG. 1). Note that the individual counterpart partition plates 94A are formed so as to secure a clearance distance and a creepage distance necessary between the adjacent counterpart terminals 92.

### Connector

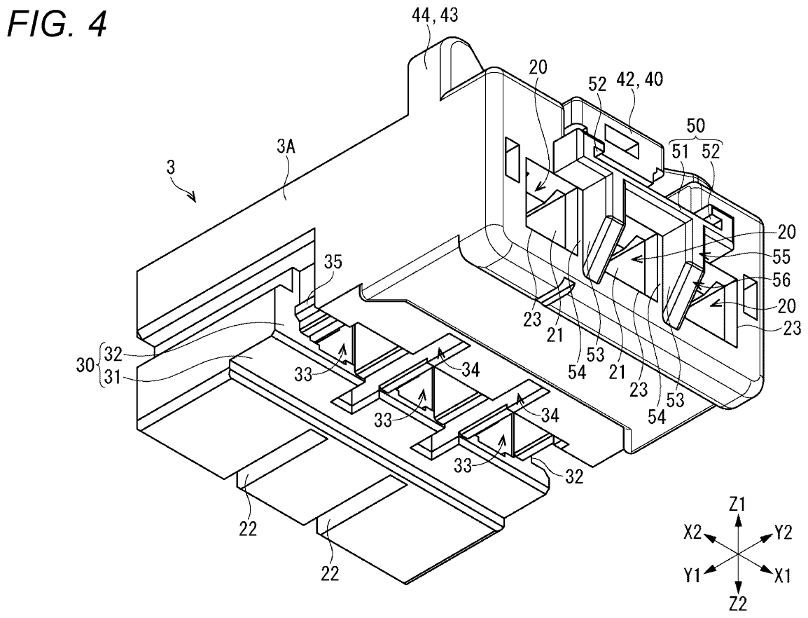

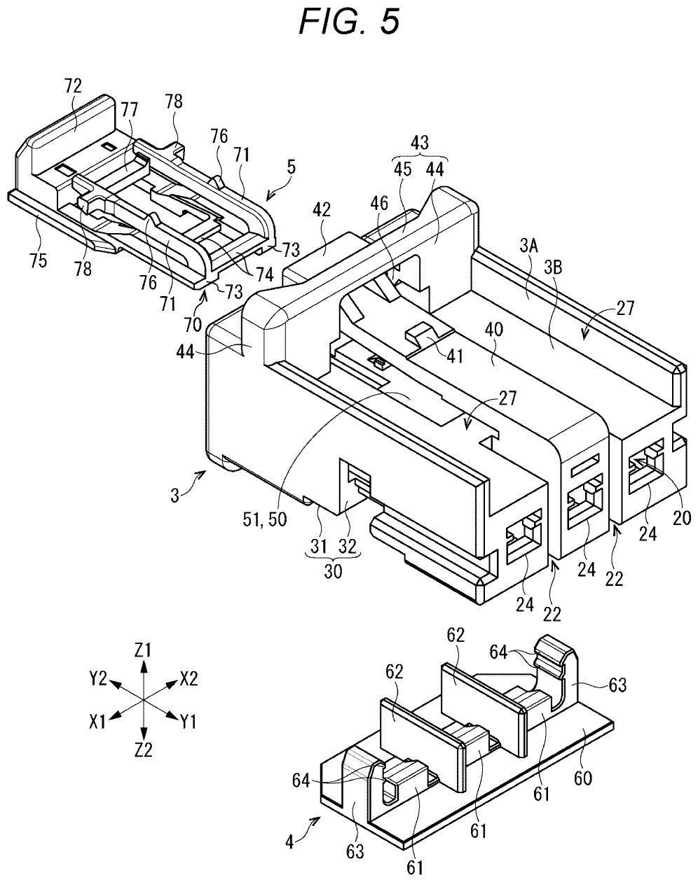

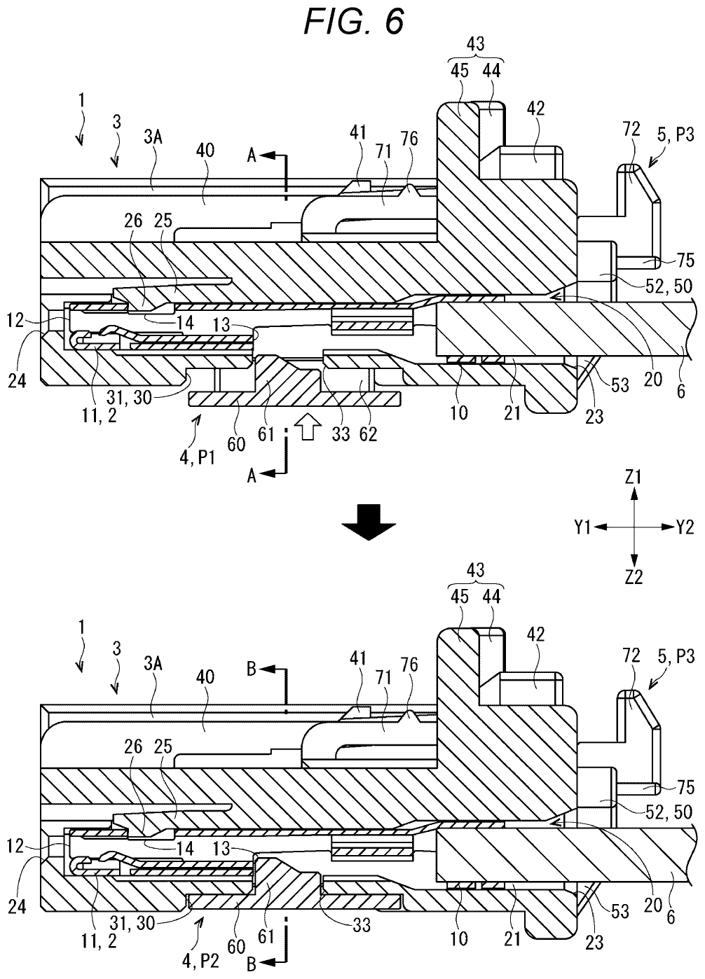

The connector 1 will be described with reference to FIGS. 1 to 6. FIG. 4 is a perspective view showing a housing 3 of the connector 1. FIG. 5 is a perspective view showing the housing 3, a retainer 4, and a connector position assurance 5. FIG. 6 is a cross-sectional view (side view) showing the attachment procedure of the retainer 4.

As shown in FIG. 3, the connector 1 includes a plurality of (e.g., three) high-voltage terminals 2, the housing 3, the retainer 4, and the connector position assurance 5. Note that since the three high-voltage terminals 2 have the same structure, one high-voltage terminal 2 will be mainly described in the present specification.

### High-Voltage Terminal

As shown in FIG. 3, the high-voltage terminal 2 is fixed to the tip end portion (front end portion) of the high-voltage cable 6. The high-voltage terminal 2 is formed by punching and bending a single metal plate. The high-voltage cable 6 includes a core wire (not shown) formed of a conductor (metal) and a covering portion (not shown) formed of an insulator and covering the core wire. The core wire is exposed by removing the covering portion on the tip end side of the high-voltage cable 6.

The high-voltage terminal 2 includes a crimping portion 10 crimped to the tip end portion of the high-voltage cable 6 and a terminal connecting portion 11 extending forward from the crimping portion 10. The crimping portion 10 has a barrel piece (not shown) crimped so as to wrap the core wire and the covering portion of the high-voltage cable 6. The terminal connecting portion 11 is formed in a rectangular tubular shape having a rectangular cross section with a long side in the transverse direction by being bent so as to wind a metal plate. On a front end surface of the terminal connecting portion 11, a connection port 12 that inserts the counterpart terminal 92 of the counterpart connector 90 is opened (see FIG. 6). Two bottom plates of the terminal connecting portion 11 are stacked, and the tip end portion (front end portion) of the bottom plate on the outer side (lower side) is folded back inward at an angle of 180 degrees (see FIG. 6). The tip end side of the inner (upper) bottom plate is bent so as to protrude upward so as to come into contact with the counterpart terminal 92 inserted from the connection port 12 with an elastic force (see FIG. 6). The bottom plate of the terminal connecting portion 11 is disposed in front of the crimping portion 10 with a retaining gap 13 interposed. In the front portion of the terminal connecting portion 11, an engagement hole 14 is opened by cutting and raising a part of the top plate.

### Housing

The housing 3 is integrally molded with a non-conductive synthetic resin, for example. As shown in FIGS. 1 and 3 to 5, the housing 3 is formed in a substantially rectangular parallelepiped shape, and a pair of side walls 3A in the transverse direction of the housing 3 extends upward from an upper surface 3B. The housing 3 includes a plurality of (e.g., three) housing chambers 20, a retaining and mounting portion 30, a lock arm 40, a fitting restriction portion 43, a placing table 50, and a plurality of (e.g., two) insulating ribs 53. Note that since the three housing chambers 20 have substantially the same structure, one housing chamber 20 will be mainly described in the present specification. For the same reason, one insulating rib 53 will be mainly described in the present specification.

### Housing Chamber

The three housing chambers 20 are provided to insert (house) the three high-voltage terminals 2 in an electrically insulated state. The three housing chambers 20 are formed adjacent to each other in the transverse direction with the two partition walls 21 interposed (see FIG. 4). That is, the three housing chambers 20 and the two partition walls 21 are alternately arranged side by side in the transverse direction, and the two partition walls 21 partition (define) the three housing chambers 20. Note that the housing chambers 20 on both sides in the transverse direction are formed between the partition wall 21 and the outer wall of the housing 3 in the transverse direction. In addition, in the housing 3, two slits 22 are formed so as to separate the front portions of the three housing chambers 20. The two slits 22 are cut rearward from the front end of the housing 3 at positions corresponding to the two partition walls 21.

The housing chamber 20 is a rectangular through hole penetrating the housing 3 in the front-rear direction. At the front end of the housing chamber 20, an insertion port 23 is opened at the rear end of the housing chamber 20 (see FIGS. 3 and 4), and a communication port 24 is opened (see FIGS. 1 and 5). The high-voltage terminal 2 is inserted into the housing chamber 20 via the insertion port 23. The counterpart terminal 92 is connected to the high-voltage terminal 2 in the housing chamber 20 via the communication port 24. The housing chamber 20 is provided with a lance portion 25 that protrudes downward from the top surface and extends forward (see FIG. 6). The lance portion 25 is formed to be displaceable in the vertical direction with an elastic force with a root portion (rear end portion) as a fulcrum. On the lower surface of the tip end portion (front end portion) of the lance portion 25, a lance claw portion 26 to be engaged with the engagement hole 14 of the high-voltage terminal 2 housed in the housing chamber 20 is provided in a protruding manner.

### Retaining and Mounting Portion

As shown in FIGS. 3 to 5, the retaining and mounting portion 30 is recessed in the lower portion of the housing 3 and in the vicinity of the middle in the front-rear direction in order to mount the retainer 4 to be described later. The retaining and mounting portion 30 includes a retaining bottom recess portion 31 recessed in the lower surface of the housing 3 and a pair of retaining side recess portions 32 formed on both side surfaces of the housing 3 in the transverse direction. The individual retaining side recess portions 32 are formed in a groove shape narrower than the retaining bottom recess portion 31 in the front-rear direction. In the forming range of the retaining bottom recess portion 31, a retaining bottom hole 33 is opened in the bottom surface of the individual housing chambers 20 (see FIG. 4). In addition, in the range where the retaining bottom recess portion 31 is formed, the partition walls 21 are a hollow double wall, and a partition bottom hole 34 is opened in the bottom surfaces of the partition walls 21 (see FIG. 4). In each of the retaining side recess portions 32 (side surfaces), a retaining claw portion 35 to be engaged with the retainer 4, described later, is provided in a protruding manner.

### Lock Arm

The lock arm 40 is provided on the upper portion of the housing 3 in order to restrict the detachment of the connector 1 fitted into the counterpart housing 91. As shown in FIGS. 1, 3, and 5, the lock arm 40 is bent rearward while protruding upward from the front end portion of the top wall of the housing chamber 20 located at the center in the transverse direction, and extends rearward. The lock arm 40 extends to the rear end portion of the housing 3 in parallel to the upper surface 3B of the housing 3. The lock arm 40 is formed to be displaceable in the vertical direction with an elastic force with a root portion (front end portion) as a fulcrum. On the upper surface of the lock arm 40, a lock claw portion 41 and a release operation portion 42 are formed. The lock claw portion 41 protrudes slightly rearward from the center of the lock arm 40 in the front-rear direction. The lock claw portion 41 is fitted into the first lock hole 97 of the counterpart housing 91 when the connector 1 is fitted into the counterpart housing 91. The release operation portion 42 is formed in a rectangular parallelepiped shape elongated in the transverse direction, and is provided at the rear end portion of the lock arm 40. The release operation portion 42 is pushed down by an operator when the connector 1 is pulled out from the counterpart housing 91.

As shown in FIGS. 1, 3, and 5, the pair of side walls 3A of the housing 3 and the lock arm 40 are disposed at intervals in the transverse direction. Therefore, a pair of guide recesses 27 partitioned by the pair of side walls 3A and the lock arm 40 is formed in the upper portion of the housing 3. The pair of guide recesses 27 is formed in a groove shape extending in the front-rear direction between the pair of side walls 3A and the lock arm 40.

### Fitting Restriction Portion

The fitting restriction portion 43 is provided in the upper portion of the housing 3 in order to restrict the insertion of the connector 1 into the counterpart housing 91. As shown in FIGS. 1, 3, and 5, the fitting restriction portion 43 is formed in an arch shape so as to straddle the lock arm 40 at the rear portion of the housing 3, specifically, between the lock claw portion 41 and the release operation portion 42. The fitting restriction portion 43 includes a pair of restriction leg portions 44 erected on the upper surface 3B of the housing 3 on both outer sides of the lock arm 40 in the transverse direction, and a restriction bridge portion 45 bridged between the upper ends of the pair of restriction leg portions 44. The pair of guide recesses 27 is formed from immediately below to the front of the fitting restriction portion 43. On the inner side surfaces of the individual restriction leg portions 44 in the transverse direction, a push restriction protrusion 46 is provided in a protruding manner. The push restriction protrusions 46 are provided on the upper side of the placing table 50, described later. Note that both left and right side surfaces of the pair of restriction leg portions 44 are flush with both left and right side surfaces of the housing 3.

### Placing Table

As shown in FIGS. 1 to 5, the placing table 50 is provided to face the housing chamber 20 and the partition wall 21 from the upper portion of the housing 3, i.e., from above (one side in the supporting direction). On the placing table 50, a connector position assurance 5, described later, is slidably installed. The placing table 50 is recessed in the upper portion of the housing 3 behind the two slits 22. The placing table 50 is formed in a groove shape extending in the front-rear direction below the lock arm 40. The placing table 50 is formed to be wider in the transverse direction than the lock arm 40.

The placing table 50 includes a sliding flat portion 51 parallel to the upper surface 3B of the housing 3 and a pair of sliding side grooves 52 continuous to both sides of the sliding flat portion 51 in the transverse direction. The pair of sliding side grooves 52 is formed such that the left and right end portions of the sliding flat portion 51 are folded back upward and inward (see FIG. 4). That is, the placing table 50 is formed in a C shape with the upper side opened when viewed from the back surface (see FIG. 4). The placing table 50 protrudes rearward from the rear end surface of the housing 3, and its protruding amount (dimension) is approximately 1 mm to 5 mm. The protruding portion of the placing table 50 is formed by thickening the sliding flat portion 51 and the sliding side groove 52.

### Insulating Rib

As shown in FIGS. 2 to 4, the insulating rib 53 extends rearward (in the pulling-out direction of the high-voltage terminal 2) from all the partition walls 21. The insulating rib 53 is formed in a plate shape in which the partition wall 21 is extended rearward, and the upper end of the insulating rib 53 is connected to the lower surface of the sliding flat portion 51 of the protruding portion of the placing table 50. That is, the insulating rib 53 supports the placing table 50 (protruding portion), which protrudes rearward (in the pulling-out direction), from the housing 3. In other words, the insulating rib 53 supports the connector position assurance 5 installed on the placing table 50 via the placing table 50. The insulating rib 53 has a function that reinforces the protruding portion of the placing table 50 and suppresses the bending of the protruding portion of the placing table 50. As a result, this ensures smooth sliding of the connector position assurance 5, which is supported by the placing table 50.

In addition, the insulating rib 53 has a function that increases a clearance distance and a creepage distance between the high-voltage terminals 2 housed in the adjacent housing chambers 20. As a result, this ensures electrical insulation between the high-voltage terminals 2 housed in the adjacent housing chambers 20. Note that the “clearance distance” is the shortest distance in the space between two high-voltage terminals 2 separated by the partition wall 21 and the insulating rib 53. The “creepage distance” is the shortest distance along the surface of the partition wall 21 and the insulating rib 53 between two high-voltage terminals 2 separated by the partition wall 21 and the insulating rib 53.

As shown in FIGS. 3 and 4, the insulating rib 53 is formed thinner in the transverse direction (adjoining direction) than the partition wall 21. At the boundary between the partition wall 21 and the insulating rib 53, a step 54 is formed. For example, the insulating rib 53 is formed to be thinner than the partition wall 21 by approximately 1 mm, and is disposed such that the center in the transverse direction is aligned with the partition wall 21. The steps 54 in the size of approximately 0.5 mm are formed on both sides of the partition wall 21 and the insulating rib 53 in the transverse direction.

As shown in FIG. 4, the insulating rib 53 is formed in a trapezoidal shape that becomes shorter in the vertical direction from the base end (front end) toward the tip end (rear end) as viewed from the side surface. The rear end surface (tip end surface in the pulling-out direction) of the insulating rib 53 has a straight surface portion 55 located on the upper side (the side of the placing table 50) and an inclined surface portion 56 located on the lower side (the side opposite to the placing table 50). The straight surface portion 55 is a vertical surface formed in parallel to the vertical direction (supporting direction). The inclined surface portion 56 is an inclined surface bent with respect to the straight surface portion 55, and is inclined forward (insertion direction) toward the lower side.

### Retainer

The retainer 4 is attached to a retaining and mounting portion 30 formed in the lower portion of the housing 3, and suppresses the insertion failure of the high-voltage terminal 2 into the housing 3 (housing chamber 20). The retainer 4 is integrally molded with, for example, a non-conductive synthetic resin. As shown in FIGS. 3 and 5, the retainer 4 includes a retaining bottom plate 60, three retaining protruding portions 61, a pair of retaining insertion plates 62, and a pair of retaining hooks 63. Note that since the three retaining protruding portions 61 have substantially the same structure, one retaining protruding portion 61 will be mainly described in the present specification. For similar reasons, one retaining insertion plate 62 will be mainly described. In addition, since the pair of retaining hooks 63 has a symmetrical structure, one retaining hook 63 will be mainly described in the present specification.

### Retaining Bottom Plate, Retaining Protruding Portion, Retaining Insertion Plate

The retaining bottom plate 60 is formed in a flat plate shape having a hexagonal shape elongated in the transverse direction by chamfering a rear corner in a planar view. The three retaining protruding portions 61 are arranged side by side at equal intervals in the transverse direction at the center portion of the retaining bottom plate 60 in the front-rear direction. The retaining protruding portion 61 is formed in a block shape protruding upward from the upper surface of the retaining bottom plate 60. The pair of retaining insertion plates 62 is arranged side by side at an interval in the transverse direction of the retaining bottom plate 60 so as to partition the three retaining protruding portions 61. The retaining insertion plate 62 is formed in a flat plate shape extending upward from the upper surface of the retaining bottom plate 60 and having a rectangular shape elongated in the front-rear direction when viewed from the side surface. The retaining insertion plate 62 is formed longer in the front-rear direction and the vertical direction and shorter (thinner) in the transverse direction than the retaining protruding portion 61. Although details will be described later, the retaining bottom plate 60 is fitted into the retaining bottom recess portion 31 of the retaining and mounting portion 30, and the retaining protruding portion 61 and the retaining insertion plate 62 are fitted into the retaining bottom hole 33 and the partition bottom hole 34 opened in the forming range of the retaining bottom recess portion 31.

### Retaining Hook

The pair of retaining hooks 63 extends upward from both end portions of the retaining bottom plate 60 in the transverse direction at the center portion of the retaining bottom plate 60 in the front-rear direction. The retaining hook 63 is formed in a rectangular parallelepiped shape having the same height as the retaining insertion plate 62. The retaining hook 63 is formed so as to be fittable to the retaining side recess portion 32 of the retaining and mounting portion 30. On the inner side surface of the retaining hook 63, a pair of retaining protrusions 64 is provided to protrude at intervals in the vertical direction (see FIG. 5). In a state where the retaining hook 63 is fitted into the retaining side recess portion 32, one of the pair of retaining protrusions 64 is engaged with the retaining claw portion 35 of the retaining side recess portion 32.

### Connector Position Assurance

The connector position assurance 5 is provided on the placing table 50 formed in the upper portion of the housing 3 so as to slide along the front-rear direction, and suppresses the fitting failure of the connector 1 with respect to the counterpart connector 90 (the counterpart housing 91). The connector position assurance 5 is integrally molded with, a non-conductive synthetic resin, for example. As shown in FIGS. 3 and 5, the connector position assurance 5 includes a fitting base portion 70, a pair of fitting arms 71, and a slide operation portion 72. Note that since the pair of fitting arms 71 has a bilaterally symmetrical structure, one fitting arm 71 will be mainly described in the present specification.

### Fitting Base Portion

The fitting base portion 70 is formed in a ladder shape by connecting a pair of base members 73 and a pair of bridge members 74. The pair of base members 73 is disposed at intervals in the transverse direction and extends in parallel in the front-rear direction. One bridge member 74 is bridged between the front end portions of the pair of base members 73, and the other bridge member 74 is bridged between the pair of base members 74 at a position rearward away from the one bridge member 73. On the outer end surface of the base member 73 in the transverse direction, a fitting sliding protrusion 75 protrudes. The fitting sliding protrusions 75 are formed from the center to the rear end in the front-rear direction of the base member 73. In the base members 73, the front side portion of the fitting sliding protrusion 75 is provided at a position shifted one step upward from the rear side portion. The fitting base portion 70 is slidably disposed on the sliding flat portion 51 of the placing table 50, and the pair of fitting sliding protrusions 75 slidably engages with the pair of sliding side grooves 52 of the placing table 50 (see FIG. 2).

### Fitting Arm

The pair of fitting arms 71 is bent rearward while protruding upward from the front end portions of the pair of base members 73, and horizontally extends rearward. The fitting arms 71 are formed to be displaceable in the vertical direction with an elastic force at a root portion (front end portion) as a fulcrum. At the center portion in the front-rear direction of the upper surface of each fitting arm 71, a fitting claw portion 76 in a triangular prism-shape protrudes. At the rear end portions of the pair of fitting arms 71, an arm bridge portion 77 is bridged. The arm bridge portion 77 is provided at a position shifted downward from the upper surfaces of the fitting arms 71. On the outer end surface in the transverse direction of the rear portions of the fitting arms 71, a push restriction portion 78 in a cubic shape is provided in a protruding manner. The push restriction portions 78 are provided behind the fitting claw portion 76 and slightly in front of the arm bridge portion 77.

### Slide Operation Portion

The slide operation portion 72 is connected to the rear end portions of the pair of base members 73. The slide operation portion 72 is formed in a block shape having an L shape when viewed from the left side surface. The slide operation portion 72 is formed so as to be fittable to the upper opening of the placing table 50 (see FIG. 2). The erected block of the slide operation portion 72 is formed to be higher than the height of the pair of fitting arms 71.

### Attachment Procedure of Retainer and Connector Position Assurance to Housing

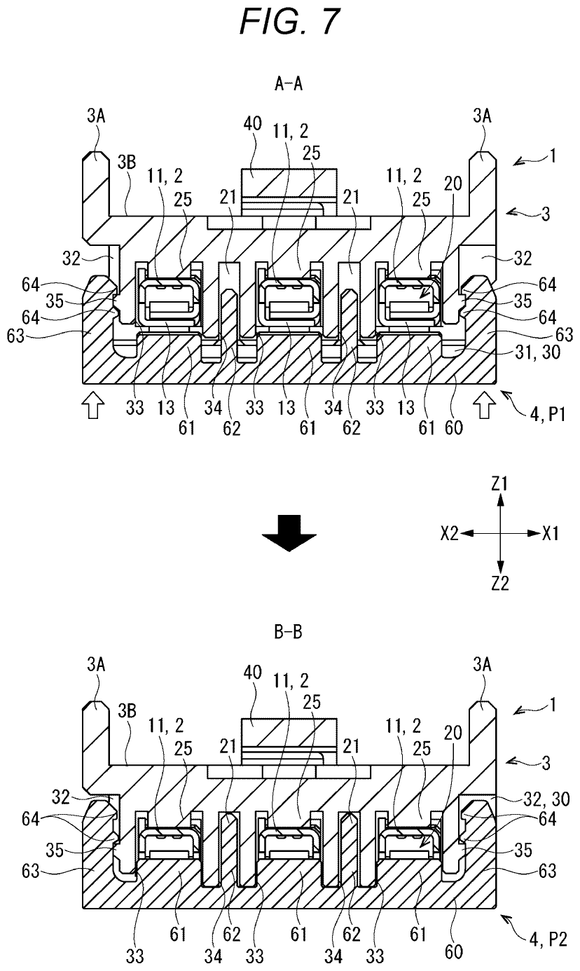

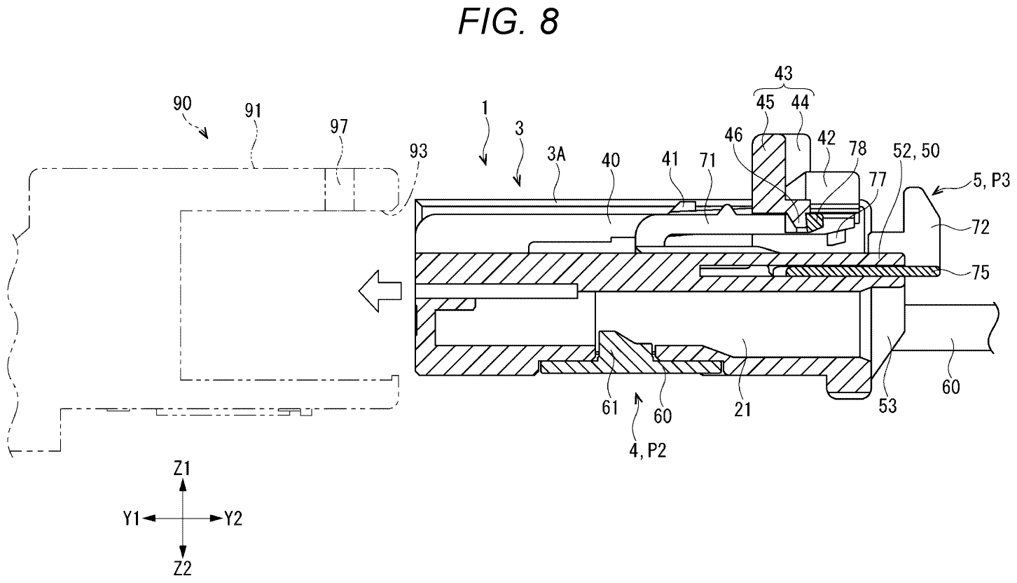

Next, referring to FIGS. 1, 6 to 8, an example of an attachment procedure of the retainer 4 and the connector position assurance 5 to the housing 3 will be described. FIG. 7 is a cross-sectional view taken along line A-A and line B-B in FIG. 6. FIG. 8 is a cross-sectional view (side view) showing the connector 1.

The operator attaches the retainer 4 to the retaining and mounting portion 30 of the housing 3. Specifically, the operator pushes the pair of retaining hooks 63 of the retainer 4 into the pair of retaining side recess portions 32 of the retaining and mounting portion 30 from below. When the pushing of the retaining hook 63 progresses, the upper retaining protrusion 64 of the pair of upper and lower retaining protrusions 64 climbs over the retaining claw portion 35 of the retaining side recess portion 32, and the retaining claw portion 35 is fitted between the pair of upper and lower retaining protrusions 64 (see the upper stage of FIG. 7). As a result, the retainer 4 is disposed at a temporary fixing position P1 where the retainer 4 is temporarily attached to the retaining and mounting portion 30 (see the upper parts of FIGS. 6 and 7). In a state where the retainer 4 is disposed at the temporary fixing position P1, the upper end portion of the retaining protruding portion 61 enters the retaining bottom hole 33, approximately the upper half of the retaining insertion plate 62 enters the partition bottom hole 34, and the retaining bottom plate 60 is detached downward from the retaining bottom recess portion 31 (see the upper stage of FIGS. 6 and 7).

Subsequently, the operator inserts the connector position assurance 5 into the placing table 50 of the housing 3 from the rear side. The fitting base portion 70 slides forward while being in contact with the sliding flat portion 51, and the pair of fitting sliding protrusions 75 slides forward while being guided by the pair of sliding side grooves 52. As the insertion of the connector position assurance 5 progresses, the push restriction portions 78 of the fitting arms 71 bumps into the push restriction protrusions 46 of the fitting restriction portion 43 (see FIG. 8). As a result, the connector position assurance 5 is restricted from moving (inserting) forward and is disposed at an unconnected position P3 temporarily attached to the placing table 50. In a state where the connector position assurance 5 is disposed at the unconnected position P3, the pair of fitting arms 71 is disposed on both sides in the transverse direction with the lock arm 40 interposed (see FIG. 1). In addition, the slide operation portion 72 is disposed behind the rear end of the placing table 50 (protruding portion), and the erected portion of the slide operation portion 72 is away rearward from the release operation portion 42 of the lock arm 40 (see the upper stage of FIG. 6 and FIG. 8).

As described above, the retainer 4 and the connector position assurance 5 are attached to the housing 3. Note that in the above attachment procedure, the connector position assurance 5 is attached to the housing 3 after the retainer 4 is attached to the housing 3. However, the present disclosure is not limited to this. For example, the retainer 4 may be attached to the housing 3 after the connector position assurance 5 is attached to the housing 3.

### Assembly Procedure of Connector

Next, referring to FIGS. 6 and 7, an example of an attachment procedure of the high-voltage terminal 2 to the housing 3, i.e., an assembly procedure of the connector 1 will be described.

The operator inserts the high-voltage terminal 2 crimped to the tip end portion of the high-voltage cable 6 into the housing chamber 20 of the housing 3. Specifically, the operator inserts the high-voltage terminal 2 into the housing chamber 20 from the insertion port 23 on the rear side. The high-voltage terminal 2 is inserted while bringing the tip end portion of the terminal connecting portion 11 into contact with the lance claw portion 26 of the lance portion 25 and elastically deforming the lance portion 25 upward. As the insertion of the high-voltage terminal 2 progresses, the lance claw portion 26 relatively moves rearward while being in contact with the upper surface of the terminal connecting portion 11 and is fitted into the engagement hole 14 of the terminal connecting portion 11 (see FIG. 6). In this state, the tip end (front end) of the terminal connecting portion 11 abuts on the edge of the communication port 24 of the housing chamber 20, and the connection port 12 of the terminal connecting portion 11 faces (communicates with) the communication port 24. In addition, the retaining gap 13 of the terminal connecting portion 11 faces (communicates with) the retaining bottom hole 33 of the housing 3 (retaining and mounting portion 30).

The operator pushes up the retainer 4 disposed at the temporary fixing position P1 and moves the retainer 4 to a main fixing position P2. When the retainer 4 moves to the main fixing position P2, the lower retaining protrusion 64 climbs over the retaining claw portion 35 of the retaining side recess portion 32, and the retaining claw portion 35 engages with the lower side of the lower retaining protrusion 64 (see the lower part of FIG. 7). As shown in the lower part of FIG. 6, the retaining protruding portions 61 of the retainer 4 pass through the retaining bottom hole 33 opened in the retaining bottom recess portion 31 and are fitted into the retaining gap 13 of the high-voltage terminal 2 disposed in the housing chamber 20. Since the front surface of the retaining protruding portion 61 interferes with the front edge of the retaining gap 13, it is possible to restrict the high-voltage terminal 2 housed in the housing chamber 20 from being pulled out. In addition, when the retainer 4 moves to the main fixing position P2, the retaining insertion plates 62 are fitted into the partition bottom holes 34 opened in the retaining bottom recess portion 31, and the retaining bottom plate 60 is fitted into the retaining bottom recess portion 31 to form the same plane as the lower surface of the housing 3.

Thus, the assembly of the connector 1 is completed.

### Connection Between Connector and Counterpart Connector

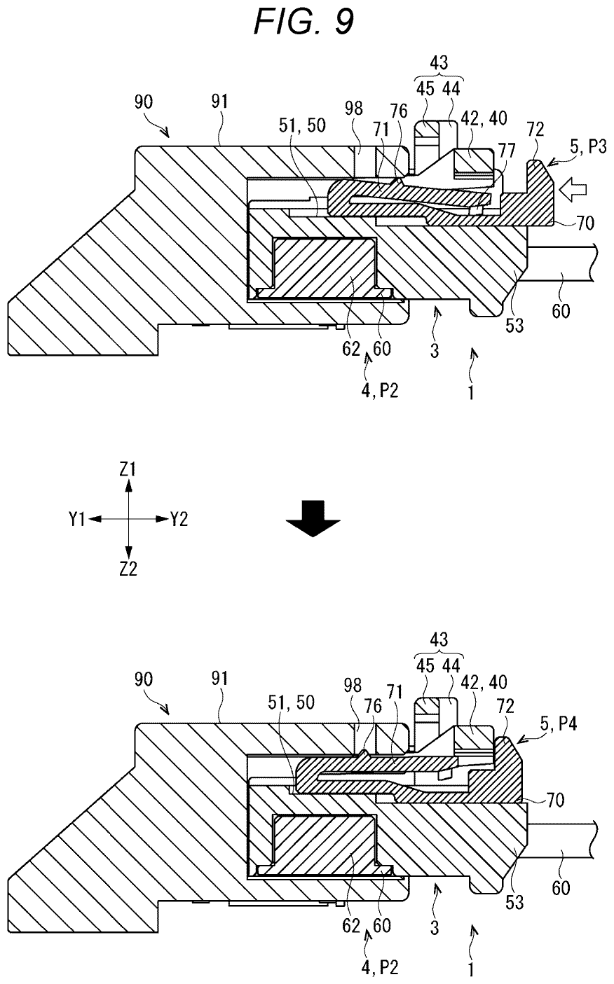

Next, referring to FIG. 9, an example of a procedure for connecting the completed connector 1 to the counterpart connector 90 will be described. FIG. 9 is a cross-sectional view (side view) showing the operation of the connector position assurance 5.

The operator inserts the connector 1 into the fitting port 93 of the counterpart connector 90 (counterpart housing 91) (see also FIG. 8). The pair of guide projecting portions 96 of the counterpart housing 91 is fitted into the pair of guide recesses 27 of the housing 3, and the housing 3 (connector 1) is inserted while being guided by the pair of guide projecting portions 96. The lock claw portion 41 protruding from the upper surface of the lock arm 40 interferes with the upper edge of the fitting port 93 of the counterpart housing 91, and the housing 3 is inserted while elastically deforming the lock arm 40 downward. When the insertion of the connector 1 progresses, the lock claw portion 41 moves rearward while being in contact with the top surface of the counterpart housing 91, is lifted by receiving the restoring force of the lock arm 40, and is fitted into the first lock hole 97 of the counterpart housing 91. In this state, the front end surface of the housing 3 of the connector 1 abuts against the front inner surface of the counterpart housing 91 (or faces the front inner surface with a slight gap interposed), and the connector 1 is generally normally fitted into the counterpart housing 91.

In the above state, the fitting claw portion 76 protruding from the upper surface of the fitting arm 71 of the connector position assurance 5 enters the counterpart housing 91 while pushing down the fitting arm 71 by interfering with the upper edge of the fitting port 93, and contacts the top surface of the counterpart housing 91 to hold the fitting arm 71 in the pushed down attitude (see the upper stage of FIG. 9). The pair of fitting arms 71 pushes the fitting base portion 70 (the connector position assurance 5) against the sliding flat portion 51 (the placing table 50). However, the placing table 50 is supported by the two insulating ribs 53 in addition to the two partition walls 21 to suppress the bending, and thus, the connector position assurance 5 can be reliably received. In addition, as the fitting arm 71 is elastically deformed downward, the push restriction portion 78 of the fitting arm 71 is separated downward from the push restriction protrusion 46 of the fitting restriction portion 43 (not shown). In addition in this state, the counterpart terminal 92 of the counterpart connector 90 passes through the communication port 24 of the housing 3 and is inserted into the connection port 12 of the high-voltage terminal 2 (not shown). The tip end side (bent portion) of the bottom plate of the terminal connecting portion 11 comes into contact with the counterpart terminal 92 with an elastic force (not shown).

Note that in the case in which the connector 1 is not normally fitted into the counterpart housing 91, the pushing down of the fitting arms 71 becomes insufficient, and the push restriction portions 78 continue to interfere with the push restriction protrusion 46 (see FIG. 8). In addition, the tip end side of the bottom plate of the terminal connecting portion 11 does not come into contact with the counterpart terminal 92 at an appropriate pressure.

Subsequently, the operator pushes the connector position assurance 5 (slide operation portion 72) disposed at the unconnected position P3 forward to move the connector position assurance 5 to a connection assurance position P4. In the case in which the connector 1 is normally fitted into the counterpart housing 91, the push restriction portion 78 is separated downward from the push restriction protrusion 46, and thus, the connector position assurance 5 can slide forward. When the pushing of the connector position assurance 5 progresses, the fitting claw portion 76 moves forward while being in contact with the top surface of the counterpart housing 91, is lifted by receiving the restoring force of the fitting arm 71, and is fitted into the second lock hole 98 of the counterpart housing 91 (see the lower part of FIG. 9). The connector position assurance 5 slides while being pushed against the sliding flat portion 51 (the placing table 50) by the pair of fitting arms 71. However, the placing table 50 is reinforced by the two insulating ribs 53 to suppress the bending, and thus, the connector position assurance 5 can be smoothly slid. In addition, the front end surface of the fitting base portion 70 of the connector position assurance 5 abuts on the front inner surface of the placing table 50 (or faces the placing table with a slight gap interposed). In addition, the erected portion of the slide operation portion 72 comes into contact with the rear surface of the release operation portion 42 of the lock arm 40 (or faces the release operation portion with a slight gap interposed, to the extent that a finger can be hooked) (see also FIG. 2). In this state, the connector position assurance 5 is disposed at the connection assurance position P4 where the forward movement (insertion) is restricted (see also FIG. 2). As described above, in the case in which the housing 3 is (normally) connected to the counterpart housing 91 of the counterpart connector 90, the connector position assurance 5 is slid from the unconnected position P3 to the connection assurance position P4 to ensure the position of the housing 3 with respect to the counterpart housing 91.

As described above, the connector 1 is connected to the counterpart connector 90 (see FIG. 2 and the lower part of FIG. 9). Note that in the case in which the connector 1 is to be separated from the counterpart connector 90, the operator may hook the finger on the slide operation portion 72 while pushing down the fitting arm 71 through the second lock hole 98, move the connector position assurance 5 to the unconnected position P3, push down the release operation portion 42, and pull out the connector 1 while releasing the locked state of the lock claw portion 41 (not shown).

In the connector 1 according to the present embodiment described above, a structure is provided in which the placing table 50 provided in the upper portion of the housing 3 slidably supports the connector position assurance 5 in the front-rear direction, and the insulating rib 53 extending rearward (in the pulling-out direction) from the partition wall 21 increases the clearance distance and the creepage distance between the adjacent high-voltage terminals 2 and supports (the protruding portion of) the placing table 50. According to this structure, the insulating rib 53 provided to secure the necessary clearance distance and creepage distance can be used both as a portion that reinforces the placing table 50 and suppresses bending. As a result, it is possible to improve the rigidity of the placing table 50, and it is possible to connect a high-voltage electric circuit while ensuring smooth sliding of the connector position assurance 5.

Meanwhile, in order to direct the connector 1 to the fitting port 93 of the counterpart housing 91, the high-voltage cable 6 extending outward from the housing 3 may be wired while being bent. Since the insulating rib 53 extends outward from the partition wall 21, free wiring of the high-voltage cable 6 may be hindered. Supposing that the insulating rib 53 is formed to have the same thickness as the partition wall 21 and the high-voltage cable 6 is bent in a direction in which the high-voltage cable 6 comes into contact with the insulating rib 53, the high-voltage cable 6 is pushed against the rear edge (corner portion) of the insulating rib 53, and a load (stress) applied to bending of the high-voltage cable 6 may increase.

On the other hand, in the connector 1 according to the present embodiment, the insulating rib 53 is thinner than the partition wall 21, and is connected to the partition wall 21 via the step 54. According to this structure, in the case in which the high-voltage cable 6 extending rearward (in the pulling-out direction) from the high-voltage terminal 2 in the housing chamber 20 is bent in the direction in which the high-voltage cable 6 comes into contact with the insulating rib 53, the high-voltage cable 6 is bent in two stages by coming into contact with two portions of the rear edge of the partition wall 21 (the tip end edge in the pulling-out direction (the corner portion of the step 54)) and the rear edge of the insulating rib 53 (the tip end edge in the pulling-out direction). As a result, the stress (load) related to the bending of the high-voltage cable 6 can be distributed to two places, and the stress related to the bending of the high-voltage cable 6 can be reduced as compared with the case in which the high-voltage cable 6 is bent at one place. Consequently, it is possible to wire (dispose) the high-voltage cable 6 extending to the outside of the housing 3 while being freely bent (improvement in the degree of freedom in routing the high-voltage cable 6).

In addition, in the connector 1 according to the present embodiment, as an example, the step 54 between the partition wall 21 and the insulating rib 53 is formed to be approximately 0.5 mm. However, the present disclosure is not limited to this, and it is possible to freely change the dimension of the step 54. For example, the step 54 is set to 1 mm or more, and thus, it is possible to improve the degree of freedom in routing the high-voltage cable 6 described above, and additionally, it is possible to increase the creepage distance as well.

Meanwhile, in the case of consideration of free routing of the high-voltage cable 6 extending outward from the housing 3, it is preferable to form the insulating rib 53 in a triangular plate shape by inclining the entire rear end surface of the insulating rib 53 (not shown). However, in the case in which the entire rear end surface of the insulating rib 53 is inclined, a necessary clearance distance and creepage distance is not able to be secured. On the other hand, the rear end surface of the insulating rib 53 has the straight surface portion 55 parallel to the vertical direction (supporting direction) and the inclined surface portion 56 inclined forward (insertion direction), and thus, it is possible to minimize the restriction on the routing of the high-voltage cable 6 while securing the necessary clearance distance and creepage distance.

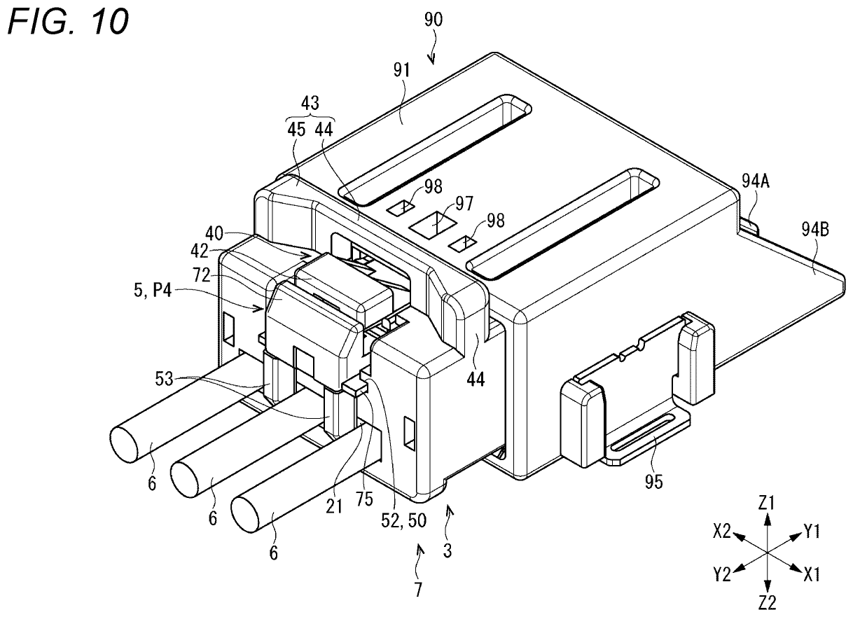

Note that in the connector 1 according to the present embodiment, the placing table 50 protrudes rearward from the rear end of the housing 3, and the insulating rib 53 supports the protruding portion of the placing table 50 (sliding flat portion 51). However, the present disclosure is not limited to this. For example, as shown in FIG. 10, in the connector 7 according to an exemplary modification of the present embodiment, the placing table 50 may not protrude from the rear end of the housing 3, and the insulating rib 53 may support the connector position assurance 5 protruding rearward (pulling-out direction) from the placing table 50 (exemplary modification). That is, the insulating rib 53 may directly support the connector position assurance 5 without interposing the placing table 50. In this case, the connector position assurance 5 is placed on the sliding flat portion 51 of the placing table 50 and the upper end surface of the insulating rib 53. In accordance with the connector 7 according to the exemplary modification of the present embodiment, it is possible to obtain the same effect as that of the connector 1 described above, for example, it is possible to connect a high-voltage electric circuit while securing smooth sliding of the connector position assurance 5.

In addition, in the connector 1 according to the present embodiment, the insulating rib 53 is formed to be thinner than the partition wall 21. However, the present disclosure is not limited to this. For example, as long as the high-voltage cable 6 is not used by being extremely bent, the insulating rib 53 may be formed to have the same thickness as the partition wall 21 (not shown).

In addition, in the connector 1 according to the present embodiment, the inclined surface portion 56 of the insulating rib 53 is bent with respect to the straight surface portion 55. However, the present disclosure is not limited to this. The inclined surface portion 56 may be bent so as to be curved with respect to the straight surface portion 55 (not shown). In addition, the inclined surface portion 56 is an inclined plane. However, the inclined surface portion 56 is not limited to this, and may be an inclined curved surface (not shown).

In addition, in the connector 1 according to the present embodiment, the insulating rib 53 is formed in a trapezoidal shape having oblique sides on the lower side when viewed from the side surface. However, the present disclosure is not limited to this, and may be formed in a trapezoidal shape having oblique sides on both upper and lower sides (not shown). In addition, as long as the necessary clearance distance and creepage distance can be secured, the insulating rib 53 may be formed in a polygonal shape other than a quadrangle (including a triangle) or may be formed in a shape including a curve such as a semicircular shape (both are not shown) when viewed from the side surface. Furthermore, as long as the high-voltage cable 6 is not used by being extremely bent, the insulating rib 53 may be formed in a quadrangular shape (not shown).

In addition, in the present embodiment, the counterpart connector 90 is provided with the three counterpart terminals 92, and the connector 1 is provided with the three high-voltage terminals 2 (the counterpart connector 90 and the housing chamber 20). However, the present disclosure is not limited to this, and two or more counterpart terminals 92 and two or more high-voltage terminals 2 may be provided (not shown). Therefore, it is sufficient that one or more partition walls 21, one or more partition insulating ribs 53, and the like in the connector 1 are provided (not shown). In addition, the numbers of the retaining protruding portions 61, the retaining insertion plates 62, and the like of the retainer 4 may be changed according to the numbers of the housing chambers 20, the partition walls 21, and the like.

In addition, in the connector 1 according to the present embodiment, the pair of fitting arms 71 is provided in the connector position assurance 5. However, the present disclosure is not limited to this, and one or three or more fitting arms 71 may be provided (not shown). In addition, although the retainer 4 is provided in the connector 1 according to the present embodiment, the present disclosure is not limited to this, and the retainer 4 may be omitted (not shown).

In addition, in the connector 1 according to the present embodiment, the terminal connecting portion 11 of the high-voltage terminal 2 is formed in a rectangular tubular shape. However, the present disclosure is not limited to this, and may have any shape as long as the terminal connecting portion 11 can be electrically connected to the counterpart terminal 92. For example, as long as the counterpart terminal 92 is formed so as to sandwich the terminal connecting portion 11, the terminal connecting portion 11 may have a single plate shape or a single rod shape (both are not shown). In addition, the counterpart connector 90 (counterpart terminal 92) is not limited to one mounted on the electric substrate 100, and may be attached to the tip end portion of the high-voltage cable 6 (not shown), for example, similarly to the connector 1.

Note that the description of the foregoing embodiment shows one aspect of the connector according to the present disclosure, and the technical scope of the present disclosure is not limited to the above embodiment. The constituent elements in the foregoing embodiment can be appropriately replaced with or combined with existing constituent elements and the like, and the description of the foregoing embodiment does not limit the content of the invention described in the claims.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. A connector connected to a counterpart connector, the connector comprising:
a housing having a plurality of housing chambers into which a plurality of high-voltage terminals fixed to tip end portions of a plurality of high-voltage cables is inserted; and
a connector position assurance that is provided in the housing so as to slide along an insertion/removal direction of the high-voltage terminal, and is slid from an unconnected position to a connection assurance position to ensure a position of the housing with respect to a counterpart housing when the housing is connected to the counterpart housing of the counterpart connector, wherein
the housing includes
at least one partition wall that partitions the plurality of housing chambers,
a placing table provided to face the housing chamber and the partition wall from one side of a supporting direction orthogonal to the insertion/removal direction and an adjoining direction of the housing chamber, and on which the connector position assurance is slidably installed, and
at least one insulating rib extending from all the partition walls in a pulling-out direction of the high-voltage terminal, increasing a clearance distance and a creepage distance between the high-voltage terminals housed in the adjacent housing chambers, and supporting the placing table protruding from the housing in the pulling-out direction or the connector position assurance protruding from the placing table in the pulling-out direction.

2. The connector according to claim 1, wherein
the insulating rib is formed to be thinner in the adjoining direction than the partition wall, and
a step is formed at a boundary between the partition wall and the insulating rib.

3. The connector according to claim 1, wherein
a tip end surface of the insulating rib in the pulling-out direction includes
a straight surface portion formed parallel to the supporting direction on a side of the placing table, and
an inclined surface portion bent with respect to the straight surface portion and inclined in an insertion direction of the high-voltage terminal toward a side opposite to the placing table.

4. The connector according to claim 2, wherein
a tip end surface of the insulating rib in the pulling-out direction includes
a straight surface portion formed parallel to the supporting direction on a side of the placing table, and
an inclined surface portion bent with respect to the straight surface portion and inclined in an insertion direction of the high-voltage terminal toward a side opposite to the placing table.
